(19) United States
(12) Patent Application Publication
(10) Pub. No.: US 2020/0257959 A1
(43) Pub. Date: Aug. 13, 2020

(54) MEMORY DEVICE HAVING AN ADDRESS GENERATOR USING A NEURAL NETWORK ALGORITHM AND A MEMORY SYSTEM INCLUDING THE SAME

(71) Applicant: SK hynix Inc., Icheon-si Gyeonggi-do (KR)

(72) Inventor: Young Jae JIN, Seoul (KR)

(73) Assignee: SK hynix Inc., Icheon-si Gyeonggi-do (KR)

(21) Appl. No.: 16/597,373

(22) Filed: Oct. 9, 2019

(30) Foreign Application Priority Data
Feb. 7, 2019 (KR) 10-2019-0014335

(51) Int. Cl. G06N 3/04; G06F 12/06

(52) U.S. Cl. CPC G06N 3/04; G06F 2212/1028; G06F 12/0646

(57) ABSTRACT

A memory device includes a memory configured to store data and a score computation block configured to compute scores for the data stored in the memory and output at least one data having a score equal to or greater than a threshold value among computed scores. The memory device also includes an address generation block configured to generate and output final position information to be accessed, based on the at least one data outputted from the score computation block. The memory device further includes a data read/write block configured to perform a read operation and a write operation for data which matches the final position information in the memory.

### CROSS-REFERENCES TO RELATED APPLICATION

The present application claims priority under 35 U.S.C. § 119(a) to Korean application number 10-2019-0014335, filed on Feb. 7, 2019, in the Korean Intellectual Property Office, which is incorporated herein by reference in its entirety.

### BACKGROUND

### 1. Technical Field

Various embodiments generally relate to an electronic device, and, more particularly, to a memory device having an address generator using a neural network algorithm and a memory system including the same.

### 2. Related Art

An artificial intelligence (AI) system is a computer system that mimics human intelligence. Unlike an existing rule-based smart system, the AI system is a system in which a machine self-learns, self-determines, and gets “smarter” over time. Where an AI system is used, the AI system may have an increased recognition rate and understand user preferences more accurately. Thus, existing rule-based smart systems are gradually being replaced with deep learning-based AI systems. AI technology includes deep learning (machine learning) and element technologies utilizing the deep learning.

Deep learning is an algorithm technology for self-classifying/learning characteristics of input data. Element technology is a technology of utilizing a deep learning algorithm, and includes various technical fields such as linguistic understanding, visual understanding, reasoning/prediction, knowledge representation, and motion control.

Deep learning largely includes a convolutional neural network (CNN), a recurrent neural network (RNN), a long short term memory (LSTM), and a memory network, for example, a neural turing machine (NTM) and a memory augmented neural network (MANN). Among these, the memory network has excellent sequential data processing performance as compared with other deep learning algorithms, but the memory network needs to transmit all data stored in a memory device to the outside whenever performing a read/write operation.

### SUMMARY

In an embodiment, a memory device may include a memory configured to store data. The memory device may also include a score computation block configured to compute scores for the data stored in the memory. And output at least one data having a score equal to or greater than a threshold value among computed scores. The memory device may further include an address generation block configured to generate and output final position information to be accessed, based on the at least one data outputted from the score computation block. The memory device may additionally include a data read/write block configured to perform a read operation and a write operation for data which matches the final position information in the memory.

In an embodiment, a memory system may include a host configured to generate and output at least one key vector based on a request inputted to the host from outside the host. The memory system may also include a memory device configured to: compute scores for data stored in a memory, by using the at least one key vector outputted from the host; search for at least one data having a score equal to or greater than a threshold value among the computed scores; generate a final position information to be accessed, based on the searched at least one data; and perform a read operation and a write operation for data which matches the generated final position information in the memory.

### BRIEF DESCRIPTION OF THE DRAWINGS

FIG. 1 is a block diagram illustrating a configuration of a memory system in accordance with an embodiment.

FIG. 2 is a block diagram illustrating a configuration of a score computation block.

FIG. 3 is a block diagram illustrating a configuration of an address generation block.

FIG. 4 is a block diagram illustrating a configuration of a data read/write block.

### DETAILED DESCRIPTION

A number of embodiments of the present teachings are directed to a memory device with reduced power consumption and improved computational efficiency. Further embodiments include a memory system incorporating the memory device with reduced power consumption and improved computational efficiency. According to some embodiments, because an address generation operation for a memory reference and a data read/write operation for a memory are performed in a memory device, it is not necessary to transmit all data stored in the memory to outside the memory, for example, to a host device. Thereby, consumed power for data transmission may be reduced and computational efficiency for performing of an operation may be improved.

A memory device having an address generator using a neural network algorithm and a memory system including the same are described below with reference to the accompanying drawings through various example embodiments.

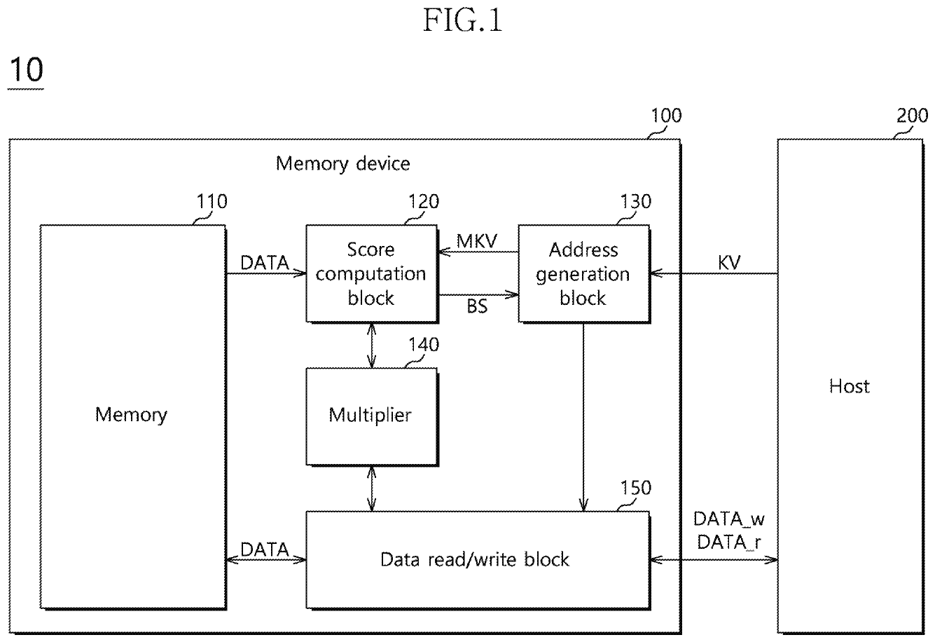

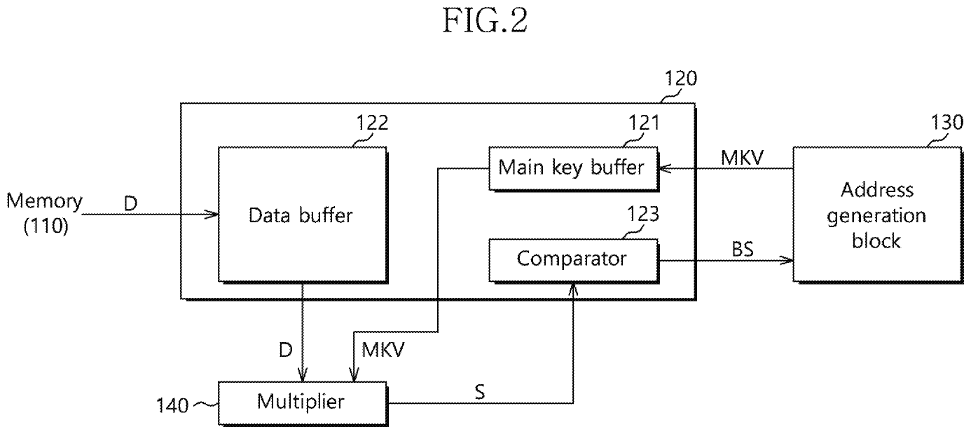

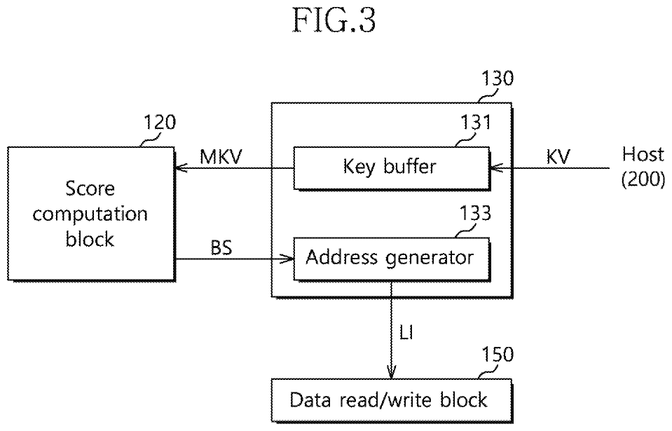

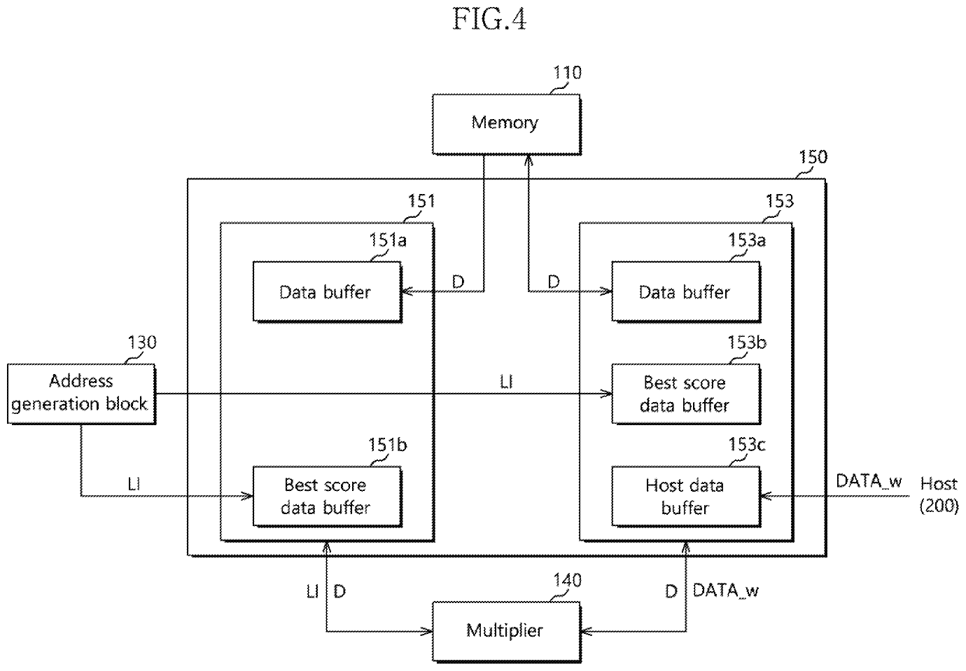

FIG. 1 is a block diagram illustrating a configuration of a memory system 10 in accordance with an embodiment. FIG. 2 is a block diagram illustrating a configuration of a score computation block, for example, a score computation block 120 shown in FIG. 1. FIG. 3 is a block diagram illustrating a configuration of an address generation block, for example, an address generation block 130 shown in FIG. 1. FIG. 4 is a block diagram illustrating a configuration of a data read/write block, for example, a data read/write block 150 of FIG. 1.

Referring to FIG. 1, the memory system 10 may include a memory device 100 and a host 200.

The host 200 may include a graphic processing unit (GPU), a central processing unit (CPU), a neural processing unit (NPU), or the like, but the host 200 is not specifically limited thereto. The host 200 may generate a key vector KV to be used by the memory device 100 in generating position information of at least one memory cell to be accessed among memory cells included in a memory 110 of the memory device 100, based on a request inputted to the host from the outside the host system 200. The host 200 may provide the generated key vector KV to the memory device 100.

The memory device 100 may generate the position information of at least one memory cell to be accessed among the memory cells included in the memory 110, based on the key vector KV provided from the host 200. The memory device 100 may read data from at least one memory cell corresponding to the generated position information and provide the read data DATA_r to the host 200, or may write data DATA_w provided from the host 200 to at least one memory cell corresponding to the generated position information.

The memory device 100 may include a memory package, such as a dynamic random access memory (DRAM) chip, a double rate data 4 (DDR4) package, a high bandwidth memory (HBM) and a hybrid memory cube (HMC), a dual in-line memory module (DIMM), or the like, but the memory device 100 is not specifically limited thereto.

The memory device 100 may include the memory 110, the score computation block 120, the address generation block 130, a multiplier 140, and the data read/write block 150.

The memory 110 may be configured to store data. The memory 110 may include a plurality of word lines (not illustrated) and a plurality of bit lines (not illustrated) disposed perpendicular to the word lines. Also, the memory 110 may include a plurality of memory cells (not illustrated) which are disposed at regions where the plurality of word lines and the plurality of bit lines intersect with each other. The memory 110 may be a volatile memory or a nonvolatile memory. For example, the memory 110 may include a dynamic RAM (DRAM), a static RAM (SRAM), a phase change RAM (PCRAM), a resistive RAM (ReRAM), a magnetic RAM (MRAM), a spin-transfer torque MRAM (STTMRAM), or the like, but the memory 110 is not specifically limited thereto.

The score computation block 120 may find data with a best score by using at least one main key vector MKV provided from the address generation block 130 and data read from the memory 110.

Referring to FIG. 2, the score computation block 120 may include a main key buffer 121, a data buffer 122, and a comparator 123.

The main key buffer 121 may be configured to temporarily store at least one main key vector MKV provided from the address generation block 130.

The data buffer 122 may be configured to store data D read from the memory 110. A size of the data buffer 122 may be smaller than a size of the memory 110. Therefore, the score computation block 120 may sequentially read data D corresponding to the size of the data buffer 122 from the memory 110 and temporarily store the data D in the data buffer 122.

The score computation block 120 may compute scores between the main key vector MKV stored in the main key buffer 121 and the data D stored in the data buffer 122, by using the multiplier 140. For example, the score computation block 120 may find data with a best score among data stored in the memory 110 by using a similarity function, but the score computation block 120 is not specifically limited thereto.

The comparator 123 may compare the scores computed by the multiplier 140 with a threshold score, find position information BS for where data with a best score is stored, and provide the position information BS to the address generation block 130. Data with a best score may mean data for which a similarity to the main key vector MKV is equal to or greater than a threshold value. A plurality of data for which similarities to the main key vector MKV are equal to or greater than the threshold value may exist in the memory 110. Due to this fact, position information BS for data with a best score, which is provided from the score computation block 120 to the address generation block 130, may be plural. For example, a single data set may represent data having the best score, or multiple data sets (also written herein as a plurality of data) may represent data having the best scores. A data set can represent a datum or some other quantum of data.

Referring to FIG. 3, the address generation block 130 may provide the main key vector MKV, from among one or more key vectors KV provided from the host 200, to the score computation block 120. The address generation block 130 may include a key buffer 131 which is configured to temporarily store the one or more key vectors KV provided from the host 200.

The address generation block 130 might not erase the remaining key vectors KV, except for the main key vector MKV provided to the score computation block 120, from the key buffer 131.

The address generation block 130 may include an address generator 133. The address generator 133 may determine final position information LI from among the plurality of position informations BS provided from the score computation block 120, that is, the position informations BS of the plurality of data with a best score, by using the remaining key vectors KV stored in the key buffer 131, and may provide the determined final position information LI to the data read/write block 150.

The data read/write block 150 may select a reference region in the memory 110 by using the final position information LI provided from the address generation block 130, and may read data stored in the selected reference region or write data to the selected reference region. The reference region may mean a region including one or more memory cells.

Referring to FIG. 4, the data read/write block 150 may include a data read block 151 and a data write block 153.

The data read block 151 may include a data buffer 151a and a best score data buffer 151b. The data read block 151 may read data D from the memory 110, and may store the data D in the data buffer 151a. The data read block 151 may store the final position information LI, provided from the address generation block 130, in the best score data buffer 151b.

The data read block 151 may search for data which matches the final position information LI stored in the best score data buffer 151b, among the data D stored in the data buffer 151a, by using the multiplier 140, and may provide the data which matches the final position information LI to the host 200.

The data write block 153 may include a data buffer 153a, a best score data buffer 153b, and a host data buffer 153c. The data write block 153 may read data D from the memory 110, and may store the data D in the data buffer 153a. The data write block 153 may store the final position information LI, provided from the address generation block 130, in the best score data buffer 153b.

The data write block 153 may search for data which matches the final position information LI stored in the best score data buffer 153b, from among the data D stored in the data buffer 153a, by using the multiplier 140, and may write data DATA_w provided from the host 200 to a position where the searched data is stored.

In this way, as an address generation operation for an access to a specific region of the memory 110 and a data read/write operation for a specific region of the memory 110 are performed in the memory device 100, it is not necessary to transmit data stored in the memory 110 to outside the memory, that is, to the host 200, whereby it is possible to reduce power consumption for interfacing between the memory device 100 and the host 200.

Moreover, a neural network algorithm used to search for a specific region for reading or writing data from or to the memory 110 may be executed in the memory device 100.

Further, since all computations such as a score computation and a multiplication for determining final position information to be accessed are executed in the memory device 100 without need of providing data stored in the memory 110 to the outside of the memory device 100, that is, to the host 200, computation efficiency may be improved.

While various embodiments have been described above, it will be understood by those skilled in the art that these described embodiments represent only a limited number of possible embodiments. Accordingly, a memory device having an address generator using a neural network algorithm and the memory system including the same, as described herein, should not be limited based on the described embodiments.

What is claimed is:

1. A memory device comprising:
a memory configured to store data;
a score computation block configured to compute scores for the data stored in the memory, and output at least one data having a score equal to or greater than a threshold value among computed scores;
an address generation block configured to generate and output final position information to be accessed, based on the at least one data outputted from the score computation block; and
a data read/write block configured to perform a read operation and a write operation for data which matches the final position information in the memory.

2. The memory device according to claim 1, wherein the address generation block comprises:
a key buffer configured to temporarily store at least one key vector provided from a host; and
an address generator configured to generate and output the final position information by using the at least one data having a score equal to or greater than the threshold value and remaining key vector, except for a main key vector among the at least one key vector stored in the key buffer.

3. The memory device according to claim 2, wherein the address generation block provides the main key vector to the score computation block.

4. The memory device according to claim 3, wherein the score computation block comprises:
a main key buffer configured to temporarily store the main key vector provided from the address generation block;
a data buffer configured to temporarily store data read from the memory; and
a comparator configured to compare a score between the main key vector and the data with the threshold value.

5. The memory device according to claim 4, further comprising:
a multiplier configured to perform matrix multiplication.

6. The memory device according to claim 5, wherein the score computation block computes a score between the main key vector and the data, by using the multiplier, and provides the score to the comparator.

7. The memory device according to claim 1, wherein the data read/write block comprises:
a data read block configured to perform the read operation; and
a data write block configured to perform the write operation.

8. The memory device according to claim 7, wherein the data read block comprises:
a data buffer configured to temporarily store data read from the memory; and
a best score data buffer configured to temporarily store the final position information provided from the address generation block.

9. The memory device according to claim 8, wherein the data read block is configured to search for data which matches the final position information among data stored in the data buffer, by using the multiplier, and provide the searched data to the host.

10. The memory device according to claim 7, wherein the data write block comprises:
a data buffer configured to temporarily store data read from the memory;
a best score data buffer configured to temporarily store the final position information provided from the address generation block; and
a host data buffer configured to temporarily store data provided from the host.

11. The memory device according to claim 10, wherein the data write block is configured to search for data that matches the final position information among data stored in the data buffer, by using the multiplier, and write the data provided from the host to a storage position of the searched data.

12. A memory system comprising:
a host configured to generate and output at least one key vector based on a request inputted to the host from outside the host; and
a memory device configured to:
compute scores for data stored in a memory, by using the at least one key vector outputted from the host;
search for at least one data having a score equal to or greater than a threshold value among the computed scores;
generate a final position information to be accessed, based on the searched at least one data; and
perform a read operation and a write operation for data which matches the generated final position information in the memory.
